(19) United States
(12) Patent Application Publication
(10) Pub. No.: US 2008/0101919 A1
(43) Pub. Date: May 1, 2008

(54) Fan and fan frame thereof

(75) Inventors: Kun-Ming Lee, Taoyuan Hsien (TW); Yi-Chen Kuo, Taoyuan Hsien (TW); Wei-Yi Lin, Taoyuan Hsien (TW); Cheng-Wei Yan, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/898,313

(22) Filed: Sep. 11, 2007

(30) Foreign Application Priority Data
Oct. 25, 2006 (TW) 095139295

(51) Int. Cl. F03D 3/02

(52) U.S. Cl. 415/60

(57) ABSTRACT

A fan includes an impeller, a motor, and a fan frame. The motor is connected to the impeller and for driving the impeller to rotate. The fan frame is for accommodating the impeller and the motor and the fan frame includes a housing, a motor base and a plurality of supporting elements. The housing has an air outlet. The motor base is disposed at the central region of the housing, and has an airflow-guiding portion located in the vicinity of the air outlet. The supporting elements are connected between the housing and the motor base.

### CROSS REFERENCE TO RELATED APPLICATIONS

This Non-provisional application claims priority under 35 U.S.C. §119(a) on patent application Ser. No(s). 095139295, filed in Taiwan, Republic of China on Oct. 25, 2006, the entire contents of which are hereby incorporated by reference.

### BACKGROUND OF THE INVENTION

1. Field of Invention

The present invention relates to a fan and a fan frame thereof. In particular, the present invention relates to a fan and a fan frame thereof that can effectively increase the area of outlet airflow.

2. Related Art

As electronic products have better performance, operate at higher frequencies and speed, and become more compact, the generated heat during the operation of the electronic products becomes a problem that may cause the instability of the electronic products. It is thus an important issue to dissipate heat for the electronic products.

A fan is a well-known heat dissipating device. It produces airflow to actively remove heat, so that the electronic device can be maintained at its normal operating temperature. With reference to FIG. 1, the fan 10 includes a fan frame 11, an impeller 12 and a motor (not shown). The impeller 12 and the motor (not shown) are disposed within the fan frame 11. The motor is connected to and drives the impeller 12 to rotate. The blades 121 of the impeller 12 thus rotate to produce airflow. In particular, the motor base 112 is disposed in the central region of the housing 111 in order to support the motor. Several ribs 113 connect the motor base 112 and the housing 111.

FIG. 2 shows another conventional fan 20. Its fan frame 21 uses static blades 214 to connect the motor base 212 and the housing 211. However, in either FIG. 1 or FIG. 2, the outgoing airflow region A of the fan 10 or 20 is limited to the area between the motor base 112/212 and the housing 111/211 only. Once the fan 10 or 20 is directly used on a heat-generating electronic device, heat generated in some local area of the electronic device directly under the fan 10/20 may not dissipate easily. That is, a part of the electronic device underneath the motor base 112/212 is blocked by the motor base 112/212, and no airflow passes there through, so that heat is accumulated there. The worst case is that the entire electronic device is damaged.

Therefore, it is an important subject to provide a fan and a fan frame that can increase the area of outlet airflow and effectively reduce the problem of heat accumulation in local areas of the electronic device.

### SUMMARY OF THE INVENTION

In view of the foregoing, the present invention is to provide a fan and a fan frame thereof that can increase the area of outlet airflow and effectively reduce the problem of heat accumulation in local areas of the electronic device. Also, the air volume and pressure are both increased to enhance heat dissipation effect.

To achieve the above, the present invention discloses a fan frame including a housing, a motor base and a plurality of supporting elements. The housing has an air outlet. The motor base is disposed in the central region of the housing and has an airflow-guiding portion located in the vicinity of the air outlet. The supporting elements are connected between the housing and the motor base.

To achieve the above, the present invention also discloses a fan including an impeller, a motor and a fan frame. The motor is connected to the impeller for driving the impeller to rotate. The fan frame accommodates the impeller and the motor. The fan frame includes a housing, a motor base and a plurality of supporting elements. The housing has an air outlet. The motor base is disposed in the central region of the housing and has an airflow-guiding portion located in the vicinity of the air outlet. The motor is disposed on the motor base. The supporting elements are connected between the housing and the motor base.

As mentioned above, the fan and the fan frame of the present invention has an airflow-guiding portion at the outer rim of the motor base, which is in the vicinity of the air outlet of the housing. For example, the airflow-guiding portion is formed by contracting the outer rim of the bottom of the motor base inwardly. In comparison with the prior art, the present invention can effectively increase the area of outlet airflow. The airflow is guided by the airflow-guiding portion toward a local region of the electronic device that is blocked by the motor base in the prior art. Therefore, there is no heat accumulation problem as in the prior art, whereby reducing the risk of damaging the entire electronic device. In addition, the design in the present invention allows the area between the motor base and the housing increasingly enlarging along the airflow direction. This further increases the air volume and pressure, and thus enhances heat dissipation effect.

### BRIEF DESCRIPTION OF THE DRAWINGS

The present invention will become more fully understood from the detailed description given herein below illustration only, and thus is not limitative of the present invention, and wherein:

FIG. 1 is a schematic view of a conventional fan and the fan frame thereof;

FIG. 2 is a cross-sectional view of the fan in FIG. 1;

FIGS. 3 and 4 are schematic views of a fan and the fan frame thereof according to the preferred embodiment of the present invention; and

FIG. 5 shows the experimental results of the air volume versus the air pressure for the conventional fan and the fan of present invention.

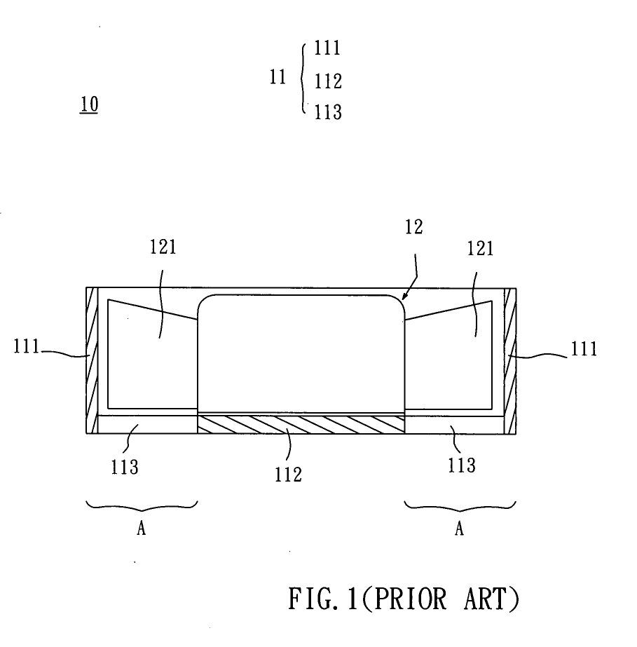

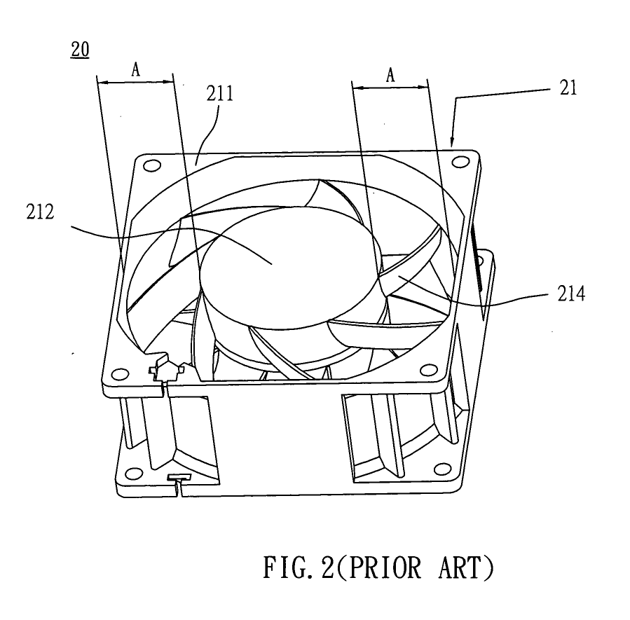

### DETAILED DESCRIPTION OF THE INVENTION

The present invention will be apparent from the following detailed description, which proceeds with reference to the accompanying drawings, wherein the same references relate to the same elements.

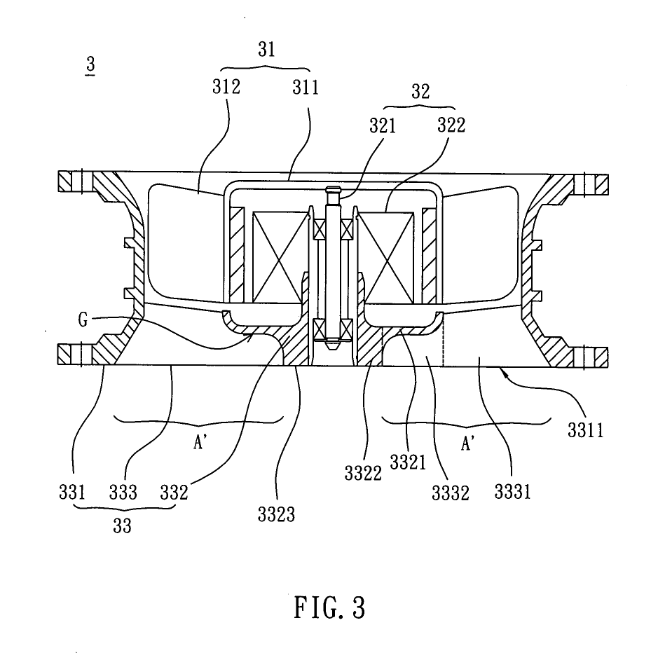

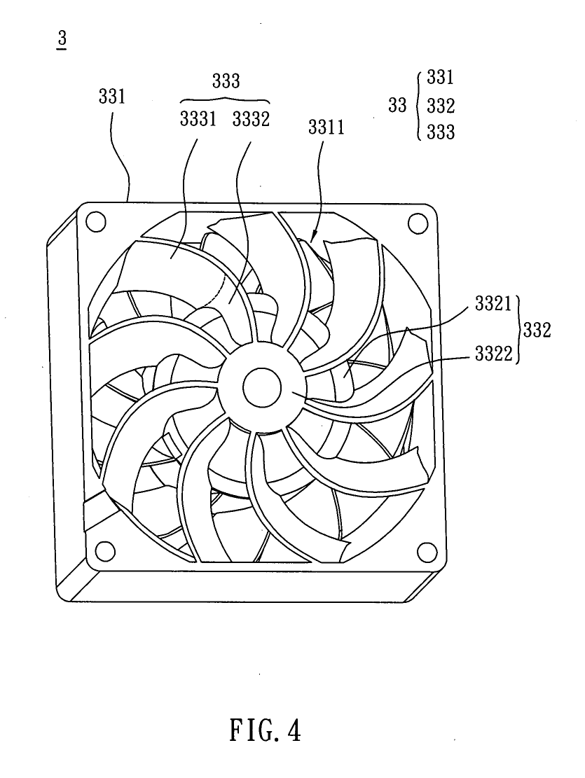

As shown in FIGS. 3 and 4, a fan 3 according to the preferred embodiment of the present invention includes an impeller 31, a motor 32 and a fan frame 33. In this embodiment, the fan 3 is, for example but not limited to, an axial-flow fan as an example. The present invention, however, is not limited to this embodiment.

The impeller 31 has a hub 311 and several blades 312 which are disposed around the hub 311. The fan frame 33 accommodates the impeller 31 and the motor 32. The fan frame 33 includes a housing 331, a motor base 332, and several supporting elements 333.

The motor 32 is disposed on the motor base 332 and preferably is covered by the hub 311 so as to drive the impeller 31 to rotate. In this embodiment, the motor 32 has a rotor structure 321 and a stator structure 322. The rotor structure 321 is connected to the hub 311. The stator structure 322 and the rotor structure 321 are disposed in a corresponding way. They interact with each other when an electrical current is imposed, whereby rotating the hub 311 to generate airflow.

The housing 331 has an air outlet 3311. The motor base 332 is disposed in the central region of the housing 331 for supporting the motor 32. The supporting elements 333 are connected between the housing 331 and the motor base 332. The supporting elements 333 are preferably static blades or ribs and may have a wing shape, a plate shape or other regular or irregular shapes. It is noted that the supporting elements 333 provide functions of not only supporting but also airflow guiding effect as long as modifying their structures.

In the vicinity of the air outlet 3311, an airflow-guiding portion G is formed at the bottom 3323 of the motor base 332. More explicitly, the motor base 332 includes a first connecting part 3321 and a second connecting part 3322. The first connecting part 3321 is connected to the second connecting part 3322. The airflow-guiding portion G is formed by contracting the outer rim of the bottom 3323 of the motor base 332. That is, the cross section of the second connecting part 3322 is smaller than that of the first connecting part 3321, thereby achieving the effect of enlarging the area of outlet airflow (i.e., the airflow region A′ of the air outlet). Further, in order to achieve a better airflow-guiding effect, the first connecting part 3321 or the second connecting part 3322 can have a guiding round angle, particularly at the interface between the motor base 332 and the supporting elements 333. In this embodiment, the first connecting part 3321 and the second connecting part 3322 are integrally formed as a single piece. Of course, the first connecting part 3321 and the second connecting part 3322 can be different objects connected to form the airflow-guiding portion G.

One end of the supporting element 333 is connected to the housing 331, and the other end is connected to the first connecting part 3321 (not shown) of the motor base 332. The other end of the supporting element 333 can also be connected to the second connecting part 3322 (see FIG. 4) of the motor base 332. More explicitly, the supporting element 333 is divided into a first part 3331 and a second part 3332. The first part 3331 is connected between the housing 331 and the first connecting part 3321 of the motor base 332. The second part 3332 is connected between first connecting part 3321 of the motor base 332 and the second connecting part 3322. For example, the second part 3332 of the supporting element 333 has a length between 0.2 and 0.8 times the length of the first part 3331 of the supporting element 333. The height of the second part 3332 of the supporting element 333 is about half the height of the first part 3331 of the supporting element 333.

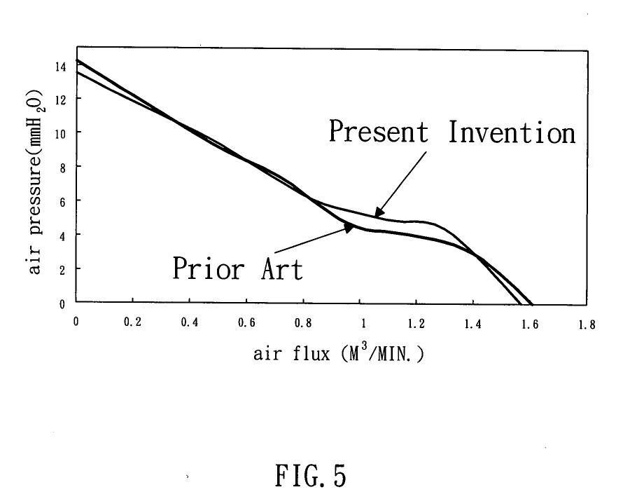

With reference to FIG. 5, the fan 3 in this embodiment and a conventional fan without the airflow-guiding portion are applied in a high-density system, respectively. Comparing the air volume and pressure of the system, it is clear to show that the present invention has a higher air pressure for the same air volume, and has a higher air volume for the same air pressure. Therefore, the fan 3 in the preferred embodiment of the present invention can effectively increase air volume and pressure, thus enhancing heat dissipation effect.

In addition, a fan frame 33 in an embodiment of the present invention includes a housing 331, a motor base 332, and several supporting elements 333. The fan frame 33 in this embodiment is applied to an axial-flow fan. The airflow-guiding portion G provided at the bottom 3323 located in the vicinity of the motor base 332 increases the area of outlet airflow, thereby increasing the air volume and pressure.

Since the component structures and functions of the fan frame 33 in this embodiment are the same as in the previous embodiment, they are not repeated herein.

In summary, the fan and fan frame of the present invention has an airflow-guiding portion at the outer rim of the motor base and in the vicinity of the air outlet of the housing. For example, the airflow-guiding portion is formed by contracting the outer rim of the bottom of the motor base. In comparison with the prior art, the present invention can effectively increase the area of outlet airflow. The airflow is guided by the airflow-guiding portion toward a local region of the electronic device that is blocked by the motor base in the prior art. Therefore, there is no heat accumulation problem as in the prior art, whereby reducing the risk of damaging the entire electronic device. In addition, the design in this present invention allows the area between the motor base and the housing increasingly enlarging along the airflow direction. This further increases the air volume and pressure, and thus enhances heat dissipation effect.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A fan frame, comprising:
a housing having an air outlet;
a motor base disposed in a central region of the housing and having an airflow-guiding portion located in the vicinity of the air outlet; and
a plurality of supporting elements connected between the housing and the motor base.

2. The fan frame of claim 1, wherein each of the supporting elements is a static blade or a rib, and each of the supporting elements has a shape of a plate or a wing.

3. The fan frame of claim 1, wherein the motor base has a bottom, and the bottom of the motor base has an outer rim contracting inwardly to form the airflow-guiding portion.

4. The fan frame of claim 1, wherein the motor base includes a first connecting part and a second connecting part, the first connecting part is connected to the second connecting part, and a cross section of the second connecting part is smaller than that of the first connecting part.

5. The fan frame of claim 4, wherein the first connecting part or the second connecting part has a guiding round angle.

6. The fan frame of claim 4, wherein one end of each supporting element is connected to the housing, and the other end of each supporting element is connected to the first connecting part only, or connected to the first connecting part and the second connecting part simultaneously.

7. The fan frame of claim 6, wherein each of the supporting elements is divided into a first part and a second part, the first part connects the housing and the first connecting part, and the second part connects both of the first connecting part and the second connecting part of the motor base.

8. The fan frame of claim 7, wherein a length of the second part of each supporting element is in the range of 0.2 to 0.8 times a length of the first part of each supporting element.

9. The fan frame of claim 7, wherein a height of the second part of each supporting element is about 0.5 times a height of the first part of each supporting element.

10. A fan, comprising:
an impeller;
a motor connected to the impeller and for driving the impeller to rotate; and
a fan frame for accommodating the impeller and the motor, the fan frame comprising:
a housing having an air outlet,
a motor base disposed in a central region of the housing and having an airflow-guiding portion located in the vicinity of the air outlet, wherein the motor is disposed on the motor base, and
a plurality of supporting elements connected between the housing and the motor base.

11. The fan of claim 10, wherein each of the supporting elements is a static blade or a rib, and each of the supporting elements has a shape of a plate or a wing.

12. The fan of claim 10, wherein the motor base has a bottom, and the bottom of the motor base has an outer rim contracting inwardly to form the airflow-guiding portion.

13. The fan of claim 10, wherein the motor base includes a first connecting part and a second connecting part, the first connecting part is connected to the second connecting part, and a cross section of the second connecting part is smaller than that of the first connecting part.

14. The fan of claim 13, wherein the first connecting part or the second connecting part has a guiding round angle.

15. The fan of claim 13, wherein one end of each supporting element is connected to the housing, and the other end of each supporting element is connected to the first connecting part only, or connected to the first connecting part and the second connecting part simultaneously.

16. The fan of claim 15, wherein each of the supporting elements is divided into a first part and a second part, the first part connects the housing and the first connecting part, and the second part connects both of the first connecting part and the second connecting part of the motor base.

17. The fan of claim 16, wherein a length of the second part of each supporting element is in the range of 0.2 to 0.8 times a length of the first part of each supporting element.

18. The fan of claim 16, wherein a height of the second part of each supporting element is about 0.5 times a height of the first part of each supporting element.
